(19) United States
(12) Patent Application Publication
(10) Pub. No.: US 2011/0029722 A1
(43) Pub. Date: Feb. 3, 2011

(54) ELECTRONIC CONTROL APPARATUS INCLUDING ELECTRICALLY REWRITABLE NON-VOLATILE MEMORY

(75) Inventor: Tsuneo MAEBARA, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/849,199

(22) Filed: Aug. 3, 2010

(30) Foreign Application Priority Data
Aug. 3, 2009 (JP) 2009-180329

(51) Int. Cl. G06F 12/00; G06F 12/02

(52) U.S. Cl. 711/103; 711/E12.001; 711/E12.008

(57) ABSTRACT

The electronic control apparatus includes an electrically rewritable non-volatile memory, a writing voltage there of being larger in absolute value than a reading voltage thereof, and a control section configured to access the non-volatile memory to perform data writing or data reading. The non-volatile memory includes a first terminal to receive the writing voltage generated by a voltage generating means disposed outside the electronic control apparatus, the first terminal being electrically isolated from the external voltage generating means.

This application claims priority to Japanese Patent Application No. 2009-180329 filed on Aug. 3, 2009, the entire contents of which are hereby incorporated by reference.

### BACKGROUND OF THE INVENTION

1. Field of the Invention

The present invention relates to an electronic control apparatus including an electrically rewritable non-volatile memory, the writing voltage thereof being larger in absolute value than the reading voltage thereof.

2. Description of Related Art

EEPROM (Electrically Erasable Programmable Read-Only Memory) is known as one of non-volatile memories capable of holding data regardless of electric power supply. However, in some cases, it is desired to inhibit some of data once written in the EEPROM from being written.

Accordingly, there has been proposed an electronic control apparatus including a register in which an inhibition flag indicating that data rewriting is inhibited is stored. For example, refer to Japanese Patent Application Laid-Open No. 8-249237. In this electronic control apparatus, the control section thereof writes data to a specific area of the EEPROM, while setting the inhibition flag in the register in response to a data write command received from the outside. As a result, even if the electronic control apparatus receives a command to write data to this specific area thereafter, the control section inhibits data writing because the control section can identify that this specific area is an area in which data writing is inhibited by referring to the register in which the inhibition flag is stored.

Such an electronic control apparatus is described also in Japanese Patent Applications Laid-Open No. 2002-99468 and No. 2008-140018.

However, as is well known, electronic devices are not completely free from malfunctioning. Hence, in the above electronic control apparatus, it is not possible to completely prevent a case in which the inhibition flag is erased due to malfunction of the control section, or data rewriting is erroneously performed although the inhibition flag is set. Incidentally, probability of occurrence of malfunction of an electronic device increases when the power supply voltage supplied thereto decreases below its rated value.

### SUMMARY OF THE INVENTION

The present invention provides an electronic control apparatus comprising:

an electrically rewritable non-volatile memory, a writing voltage there of being larger in absolute value than a reading voltage thereof; and

a control section configured to access the non-volatile memory to perform data writing or data reading;

wherein the non-volatile memory includes a first terminal to receive the writing voltage generated by a voltage generating means disposed outside the electronic control apparatus, the first terminal being electrically isolated from the external voltage generating means.

According to the present invention, there is provided an electronic control apparatus including an electrically rewritable non-volatile memory capable of reliably preventing data stored in the non-volatile memory from being erroneously rewritten.

Other advantages and features of the invention will become apparent from the following description including the drawings and claims.

### BRIEF DESCRIPTION OF THE DRAWINGS

### In the Accompanying Drawings:

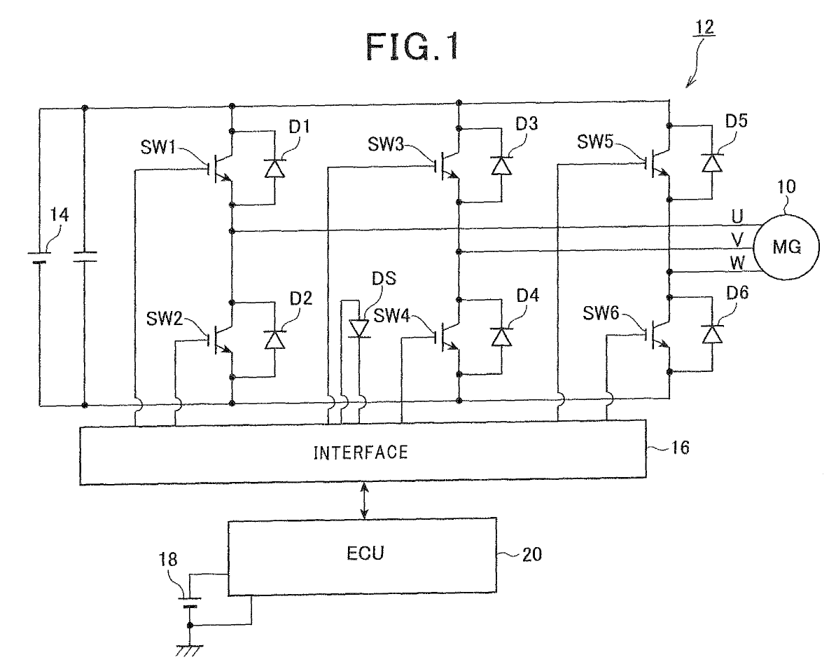

FIG. 1 is a diagram showing the structure of a control system for a hybrid vehicle including an ECU as an electronic control apparatus according to a first embodiment of the invention;

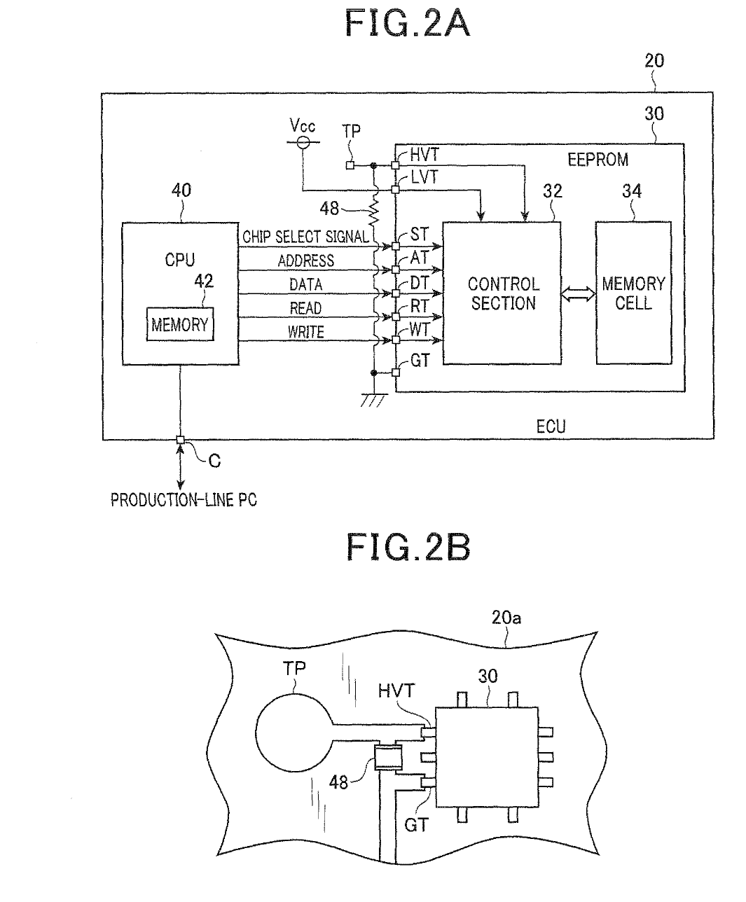

FIG. 2A is a diagram showing a part of the internal structure of the ECU;

FIG. 2B is a diagram showing a semiconductor substrate of the ECU as viewed from above the substrate;

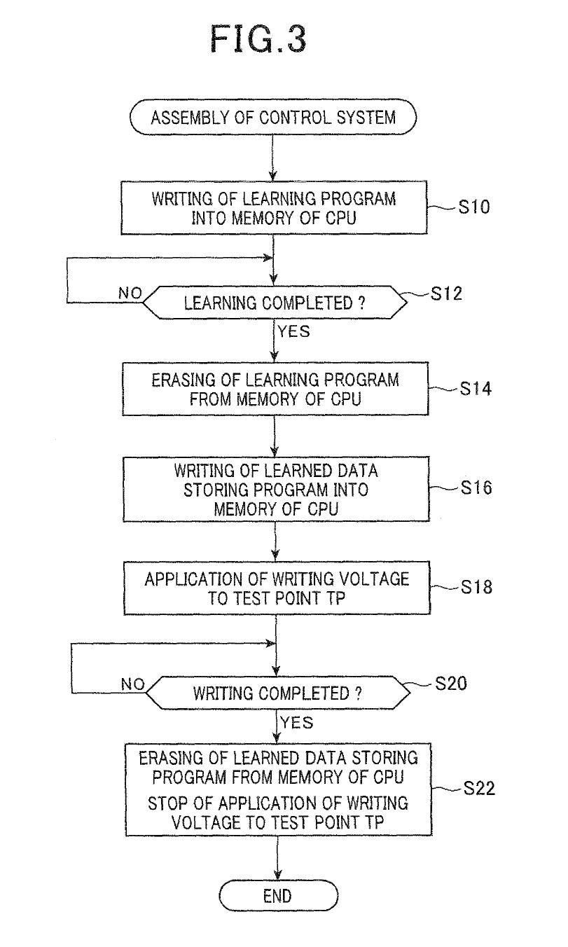

FIG. 3 is a flowchart showing operation to write a process performed when the control system is assembled;

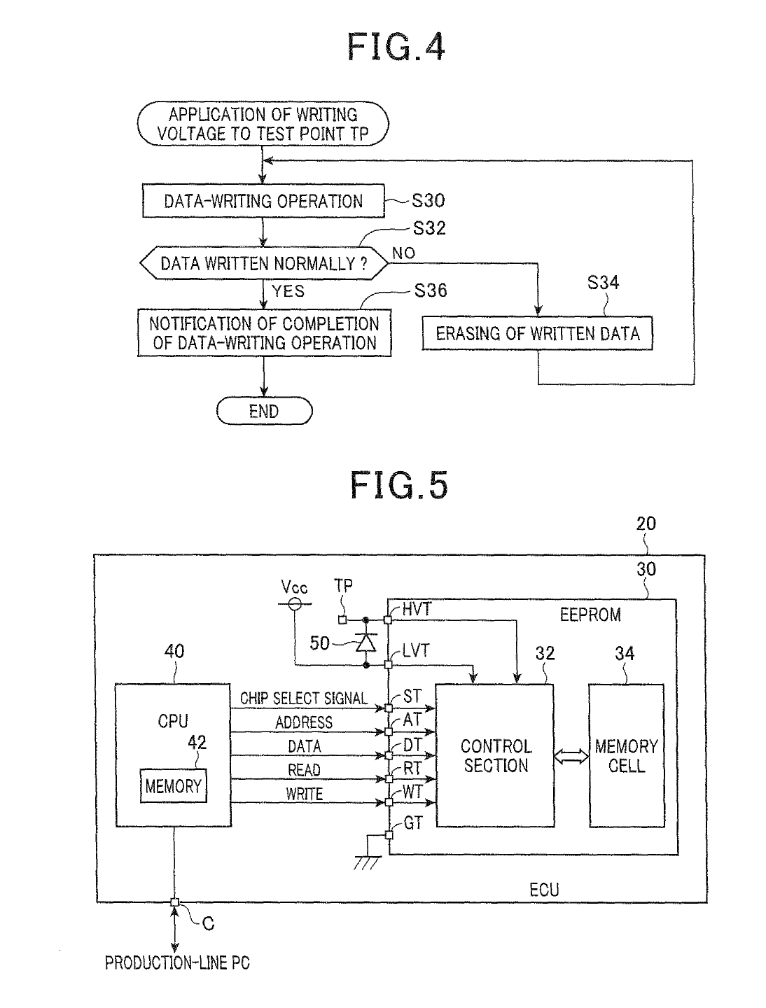

FIG. 4 is a diagram showing operation to write data into an EEPROM included in the ECU performed during the process of FIG. 3.

FIG. 5 is a diagram showing the structure of an ECU as an electronic control apparatus according to a second embodiment of the invention; and

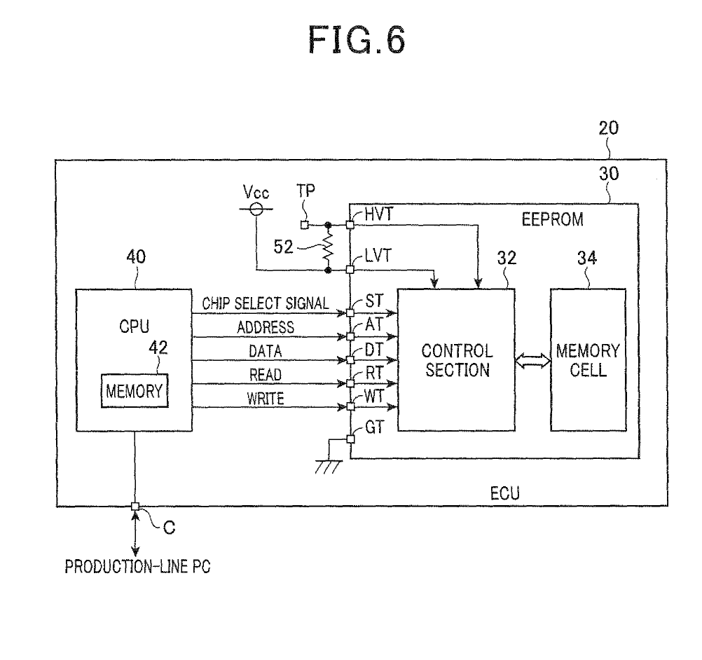

FIG. 6 is a diagram showing the structure of an ECU as an electronic control apparatus according to a third embodiment of the invention.

### PREFERRED EMBODIMENTS OF THE INVENTION

### First Embodiment

FIG. 1 is a diagram showing the structure of a control system for a hybrid vehicle including an ECU as an electronic control apparatus according to a first embodiment of the invention.

As shown in FIG. 1, the three phases (the U-phase, V-phase and W-phase) of a motor generator 10 are connected to an inverter 12. The inverter 12, which is a three-phase inverter, applies the voltage of a high-voltage battery 14 to the three phases of the motor generator 10 in an appropriate manner. In more detail, the inverter 12 is constituted of a series connection of switching elements SW1 and SW2, a series connection of switching elements SW3 and SW4, and a series connection of switching elements SW5 and SW6, which are operated to connect each of the three phases of the motor generator 10 to the positive or negative terminal of the high voltage battery 14. The connection node between the switching elements SW1 and SW2 is connected to the U-phase of the motor generator 10. The connection node between the switching elements SW3 and SW4 is connected to the V-phase of the motor generator 10. The connection node between the switching elements SW5 and SW6 is connected to the W-phase of the motor generator 10. Each of these switching elements SW1 to SW6 is constituted of an IGET (Insulated Gate Bipolar Transistor). The inverter 12 includes free wheel diodes D1 to D6 each of which is inverse-parallel connected to a corresponding one of the switching elements SW1 to SW6.

Further, the inverter 12 includes a temperature-sensitive diode DS to measure the temperature of the inverter 12.

The switching elements SW1 to SW6 are operated by an electronic control unit (ECU) 20 through an interface 16, the ECU 20 being powered by a low voltage battery 18. In operating the switching elements SW1 to SW6, the ECU 20 takes into account the temperature of the inverter 12 received from the temperature-sensitive diode DS through the interface 16.

However, if the output characteristic of the temperature-sensitive diode DS deviates from a reference characteristic, the ECU 20 cannot correctly keep track of the temperature of the inverter 12. If such deviation due to individual difference is present, the controllability of the control system may be lowered. Accordingly, in this embodiment, the ECU 20 stores therein results of learning of individual difference of the temperature-sensitive diode DS before the ECU 20 is shipped from the manufacturer.

FIG. 2A shows a part of the internal structure of the ECU 20, the part being mainly for storing learning results.

As shown in this figure, the ECU 20 includes an EEPROM 30 and a CPU 40. The EEPROM 30 is a PROM of the floating gate type capable of erasing and rewriting data. The EEPROM 30 serves as a storage means to store learned results explained later.

The EEPROM 30 includes a control section 32 and a memory cell 34. The memory cell 34 is constituted of a plurality of chips the data storage areas of which have the same addresses. The control section 32 accesses a data storage area corresponding to a specific address of a specific one of the chips in the memory cell 34 in response to a command received from the outside.

The EEPROM 30 includes, as an interface for communication with the outside, a write terminal WT to which a write command signal is applied, and a read terminal RT to which a read command signal is applied. Further, the EEPROM 30 includes a data terminal DT through which data to be written is inputted and data to be read is outputted, an address terminal AT to which a signal for chip addressing is applied, and a chip select terminal ST to which a signal for chip selection is applied. Further, the EEPROM 30 includes a ground terminal GT whose voltage serves as a reference voltage when the EEPROM 30 is in operation, and a low voltage terminal LVT as an operating voltage terminal thereof. Further, the EEPROM 30 includes a high voltage terminal NVT to which a high voltage to write data into the memory cell 34 or erase data from the memory cell 34 is applied. Since the voltage necessary to write data into or erase data from the memory cell 34 (14 V, for example) is higher than the voltage necessary to operate the control section 32 or to read data from the memory cell 34 (5 V, for example), the high voltage is required for data writing or data erasing separately from the operating voltage.

The high voltage terminal HVT is connected to a test point TP. FIG. 2B is a diagram showing a semiconductor substrate 20a of the ECU 20 as viewed from above the substrate 20a. As shown in FIG. 2B, the test point TP, to which the high voltage terminal HVT is connected, is a terminal end of a high voltage electrical path. The test point TP is not connected to a power supply means inside the ECU 20. The test point TP, which is a member to enable electrical contact with the outside, has a sufficiently large surface area when viewed from the above compared to the high voltage terminal HVT. The test point TP is located at around the midpoint of the substrate 20. The reason is that the test point TP is provided in the semiconductor substrate 20a separately from the interface provided for the ECU 20 for communication with the outside, and is not required to contact with the outside while the ECU 20 is in operation.

The high voltage terminal HVT is connected to the ground terminal GT through a resistor 48. This is for fixing the voltage of the high voltage terminal HVT in order to increase noise resistance of the EEPROM 30. Since the high voltage terminal HUT is not connected to the power supply means, the high voltage terminal HVT is in a floating state if it not connected to the ground terminal GT. In this case, the noise resistance of the EEPROM is lowered.

The CPU 40 includes therein a memory 42. When the control system is assembled, and the ECU 20 and the inverter 12 are connected together, a process shown in FIG. 3 is performed by a computer of the production line (referred to as “production-line PC” hereinafter). At this time, a learning program is written into the memory 42 through a connector C provided in the ECU 20 as an interface with the outside. The CPU 40 performs learning in accordance with this learning program during this process.

Next, the process of the flowchart shown in FIG. 3 is explained. This process is performed by the production-line PC when the ECU 20 and the inverter 12 are connected together.

This process begins by writing into the memory 42 of the CPU 40 the learning program for learning characteristics of various members of the control system such as the output characteristic of the temperature-sensitive diode DS at step S10. At this time, the learning program is sent from the production-line PC to the memory 42 of the CPU 40 through the connector C of the ECU 20. When a notification that the learning in accordance with the learning program has been completed is transmitted from the CPU 40 to the production-line PC (YES at step S12), the learning program is erased from the memory 42 at step S14.

Thereafter, at step S16, a program for storing learned data (results of the learning) is written into the memory 42 of the CPU 40. At this time, the learned data storing program is sent from the production-line PC to the memory 42 of the CPU 40 through the connector C of the ECU 20. At subsequent step S18, the production-line PC operates a voltage applying means (not shown) to apply the high voltage to the test point TP as a writing voltage. At this time, the high voltage terminal HTV is also applied with the high voltage. When a notification that writing of the learned data storing program has been completed is transmitted from the CPU 40 to the production-line PC (YES at step S20), the learned data storing program is erased from the memory 42 at step S22, and the application of the writing voltage to the test point TP is stopped.

FIG. 4 is a flowchart showing operation in accordance with the program stored in the memory 42 at step 16. This operation is repeatedly performed at regular time intervals by the CPU 40.

This operation begins by writing the learned data into the EEPROM at step S30. In more detail, at step S30, the address of a specific one of the chips of the memory cell 34 within the EEPROM 30 is selected by the chip select signal and address signal, and the data is stored in the data storage area having the selected address through the data terminal DT. At this time, the control section 32 uses the high voltage applied to the test point TP and the high voltage terminal HVT. At subsequent step S32, it is determined whether or not the data has been written normally. In more detail, at step S32, the address of the specific one of the chips of the memory cell 34 is selected by the chip select signal and address signal, and the data stored in the data storage area having the selected address is read by the CPU 40, and the data is compared with the data stored in the CPU 40.

If the determination result at step S32 is negative, the operation proceeds to step S34 to erase the written data, and then returns to step S30. On the other hand, if the determination result at step S32 is affirmative, the operation proceeds to step S36 to notify through the connector C the production-line PC that the writing has been completed.

When step S36 is completed, the operation is terminated. The first embodiment described above provides the following advantages.

(1) The EEPROM 30 does not include means for generating the high voltage used to data writing or erasing, and its high voltage terminal HVT is not connected to such means for generating the high voltage. This makes it possible to prevent that the data stored in the EEPROM 30 is erroneously rewritten.

(2) The high voltage terminal HVT is connected to the test point TP. This makes it possible to supply the high voltage for data rewriting to the EEPROM 30 easily.

(3) The high voltage terminal HVT is grounded through the resistor 48. This makes it possible to improve the noise resistance compared to a case where the high voltage terminal HVT is in a floating state. In addition, since the voltage difference between the ground terminal GT and the high voltage terminal HVT can be made sufficiently smaller than the voltage used for data rewriting or erasing, it is possible to reliably prevent that the data is erroneously rewritten.

(4) The ECU 20 is used in the vehicle control system. The voltage of a vehicle battery is likely to vary to a large extent, and accordingly the operation of the control section 32 is likely to be unstable. As a result, the data stored in the EEPROM may be erroneously rewritten. Accordingly, the ECU 20 is particularly advantageous when it is used for the vehicle control system.

(5) The data regarding individual difference of the temperature-sensitive diode DS is written in the EEPROM 30. Since this data is data which should be absolutely protected from being rewritten, storing this data in the EEPROM 30 is particularly advantageous.

### Second Embodiment

Next, a second embodiment of the invention is described with particular emphasis on the difference with the first embodiment.

FIG. 5 is a diagram showing a part of the internal structure of the ECU 20 of this embodiment, the part being mainly for storing the learned results. In FIG. 5, the reference numerals identical to those shown in FIG. 2 represent the same elements.

As shown in FIG. 5, in this embodiment, the means to fix the voltage of the high voltage terminal HVT is constituted including the low voltage terminal LVT. In more detail, the low voltage terminal LVT and the high voltage terminal HVT are connected to each other through a diode 50 whose forward direction is from the low voltage terminal LVT to the high voltage terminal HVT. This configuration makes it possible to fix the voltage of the high voltage terminal HVT using the low voltage terminal LVT, and to prevent the low voltage terminal LVT from being applied with the high voltage at the time of applying the high voltage to the test point TP.

According to the second embodiment, other than the above advantages (1), (2), (4) and (5) provided by the first embodiment, the following advantage can be obtained.

(6) The voltage of the high voltage terminal HVT is fixed by using the low voltage terminal LVT. This makes is possible to improve the noise resistance of the high voltage terminal HVT.

### Third Embodiment

Next, a third embodiment of the invention is described with particular emphasis on the difference with the second embodiment.

FIG. 6 is a diagram showing a part of the internal structure of the ECU 20 of this embodiment, the part being mainly for storing the learned results. In FIG. 6, the reference numerals identical to those shown in FIG. 5 represent the same elements.

As shown in FIG. 6, in this embodiment, a resistor 52 is connected between the high voltage terminal HVT and the low voltage terminal LVT. It is preferable that the resistance of the resistor 52 is as large as possible in order to reduce the power consumed by the resistor 52 while the test point TP is applied with the high voltage.

The third embodiment provides the similar advantages as the advantages (1), (2), (4) and (5) provided by the first embodiment, and the advantage (6) provided by the second embodiment.

It is a matter of course that various modifications can be made to the above embodiments as described below.

In the above embodiments, the ECU 20 does not include means to generate a voltage higher than the voltage necessary for data writing or erasing. However, in a case where a resolver is used to detect the rotation angle of the motor generator 10, for example, the ECU 20 may include means to generate a relatively high voltage (20 V, for example) to be applied to the resolver. Also in this case, supplying the writing voltage can be supplied to the ECU 20 by applying the writing voltage to the test point TP from the outside. Alternatively, a wiring for connection between means to apply the voltage to the resolver and the high voltage terminal HVT of the EEPROM 30 may be provided on the substrate 20a so that the writing voltage can be applied to the EEPROM 30 through this wiring. In this case, after completion of data writing, the means to apply the voltage to the resolver and the high voltage terminal HVT is electrically isolated from each other by cutting the wiring, for example.

In the above embodiments, the high voltage for data writing is supplied to the EEPROM 30 using the test point TP. However, the high voltage may be supplied to the EEPROM 30 through the connector C serving as an interface between the electronic components mounted on the substrate 20a and the outside. Further, the high voltage may be supplied to the EEPROM 30 by directly contacting an external voltage applying member to the high voltage terminal HVT of the EEPROM 30.

In the above embodiments, the voltage of the high voltage terminal HVT is fixed to a predetermined voltage. However, the high voltage terminal HVT may be fixedly connected to a filter for removing assumed noise frequency components, though the advantage (1), (2), (4) and (5) can be obtained even if the high voltage terminal HVT is not electrically connected to any member.

The above embodiments are configured such that the learning program and the learned data storing program are once stored in the memory of the CPU 40, and are erased before shipment. However, they may be stored in a ROM in the ECU 20.

In the above embodiments, the results of the learning are stored in the EEPROM 30 as learned data. However, it may be a part of a control program for controlling a controlled variable of the motor generator 10 performed by the ECU 20. The important point is that it should be stored as data inhibited from being erased. However, in this case, since data to be obtained for the first time after the control system is assembled is obtained by the ECU 20 itself, and it is difficult to store the obtained data in the ROM thereafter, it is preferable to store the data in the EEPROM 30. Since the temperature-sensitive diode DS is a silicon-based element which exhibits very little secular change, storing the learned data regarding individual difference as calibration data is highly advantageous.

Although the above embodiments are directed to a control system for a hybrid vehicle, the present invention can be also applied to a control system for a vehicle having a gasoline engine or a diesel engine as its single prime mover. Also in this case, it is advantageous to store data regarding injecting performance deviation due to individual difference of a fuel injection valve, or measurement characteristic deviation of an element to measure the temperature of a driver circuit to drive the fuel injection valve in the EEPROM 30.

The above explained preferred embodiments are exemplary of the invention of the present application which is described solely by the claims appended below. It should be understood that modifications of the preferred embodiments may be made as would occur to one of skill in the art.

What is claimed is:

1. An electronic control apparatus comprising:
an electrically rewritable non-volatile memory, a writing voltage there of being larger in absolute value than a reading voltage thereof; and
a control section configured to access the non-volatile memory to perform data writing or data reading;
wherein the non-volatile memory includes a first terminal to receive the writing voltage generated by a voltage generating means disposed outside the electronic control apparatus, the first terminal being electrically isolated from the external voltage generating means.

2. The electronic control apparatus according to claim 1, further comprising a second terminal for connection with an external device, the second connector being electrically connected to the first terminal.

3. The electronic control apparatus according to claim 1, further comprising a voltage fixing section to fix a voltage of the first terminal.

4. The electronic control apparatus according to claim 3, wherein the non-volatile memory includes a third terminal applied with a reference voltage, the voltage fixing section electrically connecting the first terminal to the third terminal.

5. The electronic control apparatus according to claim 3, wherein the non-volatile memory includes a third terminal to receive the reading voltage, the voltage fixing section including one of a diode and a resistor to make connection between the second terminal and the third terminal.

6. The electronic control apparatus according to claim 1, wherein the electronic control apparatus is mounted on a vehicle to control a vehicle control system of the vehicle.

7. The electronic control apparatus according to claim 6 wherein data regarding individual differences of components constituting the vehicle control system is stored in the non-volatile memory.
